(19) United States
(12) Patent Application Publication
(10) Pub. No.: US 2014/0323197 A1
(43) Pub. Date: Oct. 30, 2014

(54) SYSTEM AND METHOD FOR CONDUCTING A WAGERING GAME

(71) Applicant: Triamble Pty Limited, Bronte (AU)

(72) Inventors: Stuart O'Brien, Bronte (AU); Michael Thomas McNee, Bronte (AU)

(21) Appl. No.: 14/328,840

(22) Filed: Jul. 11, 2014

Related U.S. Application Data
(63) Continuation-in-part of application No. PCT/AU2013/000018, filed on Jan. 11, 2013.

(30) Foreign Application Priority Data
Jan. 12, 2012 (AU) 2012200162
Sep. 12, 2012 (AU) 2012903982
Dec. 2, 2013 (AU) 2013263863

(51) Int. Cl. G07F 17/32

(52) U.S. Cl. CPC G07F 17/3286
USPC 463/18

(57) ABSTRACT

A method of conducting a wager game comprises allowing a player to place individual game wagers across a plurality of games to be played in the wager game. A common draw phase is implemented in which a plurality of symbols are randomly drawn from a symbol draw set to determine outcomes of the plurality of games, such chat at least one of the drawn symbols is used for determining, at least in part, the outcome for each of the plurality of individual games.

### Field of the Invention

The present invention relates to gaming systems, game controllers and methods of gaming. It relates, for example, to electronic gaming machines and to networked gaming systems, such as Internet-based gaming systems. It also relates to lottery style wager games.

### BACKGROUND OF THE INVENTION

Gambling is one of the world's big industries and although technology has had an appreciable impact on the way in which players participate in wager games it is still very much an industry built around traditional games. For example, the game of Keno which is a very popular lottery style game played in clubs, hotels and the like, has been around in one form or another for centuries.

It would be advantageous if there was provided a new form of wager game which was both exciting to play and provided attractive odds. It would also be advantageous to provide a game whereby the prize structure is easily understood by players and the resultant prizes awarded on a frequent basis.

### SUMMARY OF THE INVENTION

In accordance with a first aspect there is provided a method of conducting a game in which a plurality of draws are concurrently playable, the method comprising:
providing a symbol set comprising a triangular number of symbols;
implementing a first tier draw in which randomly selected symbols from the symbol set are allocated to players until each of the symbols in the symbol set have been allocated, the symbols being allocated responsive to receiving player wagers of a first predefined value;
randomly determining one of the symbols in the symbol set to be a winning symbol; and
awarding a prize to a player in the first tier draw having been allocated the winning symbol, the prize being funded from the received player wagers.

In an embodiment the method further comprises implementing a further first tier draw which is played concurrently with the initial first tier draw in response to receiving further player wagers of the first predefined value.

In an embodiment players in the further first tier draw are allocated randomly selected symbols from the same symbol set as for the initial draw.

In an embodiment the method further comprises awarding a prize to a player having been allocated the winning symbol in the further first tier draw.

In an embodiment, the prize awarded in the farther first tier draw is funded from the farther first tier draw wagers.

In an embodiment the method further comprises implementing one or more second tier draws which are to be played concurrently with the first tier draw(s), responsive to receiving player wagers of a second predefined value and whereby prizes awarded in the second tier draw are funded from the respective second tier draw wagers.

In an embodiment the method further comprises displaying the randomly selected prize winning symbol on a display screen.

In an embodiment the method further comprises presenting each of the symbols within the symbol set in a triangular number matrix, the prize winning symbol being located at one of the vertexes of the matrix.

In an embodiment the method further comprises rotating the matrix for a period such that at the end of the rotation the prize winning symbol is located in a prize winning position to thereby provide players with an indication that it is the prize winning symbol.

In an embodiment the method further comprises periodically playing further games and wherein only draws in which all symbols nave been allocated prior to display of the new randomly selected winning symbol are eligible for play.

In an embodiment the method further comprises allocating a portion of the received player wagers from each draw as house takings.

In an embodiment, where the number of symbols in the symbol set is n, the portion of the house takings is 1/n times the accumulated received wager value for the respective draw.

In an embodiment a value of the prize awarded to the player is n−2/n times the accumulated received wager value for the respective draw.

In an embodiment the method further comprises automatically allocating the prize winning player a randomly selected symbol for a draw in the next game, the allocation being funded from the remaining portion of the accumulated received wager value for the respective draw.

In an embodiment the method further comprises continuing to automatically allocate the player randomly selected symbols for subsequent draws where the allocated symbols are winning symbols.

In an embodiment the method further comprises awarding the player a jackpot prize when the player has been allocated winning symbols for a set number of draws.

In an embodiment the set number of draws is six.

In an embodiment the jackpot is funded from a portion of the house takings.

In an embodiment the value of the prize awarded to the player is n−1/n times the accumulated received wager value for the respective draw.

In an embodiment the value of the prize awarded to the player is either n−2/n or n−2/n times the accumulated received wager value for the respective draw, dependent on the player wager value.

In an embodiment the triangular number of symbols is at least six. In an embodiment the triangular number of symbols is ten.

In accordance with a second aspect of the present invention there is provided a gaming controller for providing a game, the controller comprising:
a symbol store for storing a triangular number of symbols;
a draw management module operable to implement a draw in which randomly selected symbols from the symbol set are allocated to players until each of the symbols have been allocated, the symbols being allocated responsive to receiving player wagers of a first predefined value;
a symbol selector module operable to randomly determine one of the symbols in the symbol set to be a winning symbol; and
an award module operable to award a prize to a player in the draw having been allocated the winning symbol, the award being funded from the received player wagers.

In an embodiment the triangular number is at least six. In an embodiment the triangular number is ten.

In accordance with a third aspect of the present invention there is provided a gaming system comprising:
a gaming controller in accordance with the second aspect described above; and
one or more player terminals located remotely of the gaming controller and in data communication therewith, the player terminals operable to enter respective players into the first tier draw responsive to a wager of the first predefined value being placed by the players.

In an embodiment the one or more player terminal player terminals are further operable to provide the players with a confirmation of the entry and an indication of the symbols allocated thereto.

In an embodiment the system further comprises one or more displays for displaying the winning symbol.

In an embodiment the game is conducted over the Internet and wherein the player terminals are personal computers implementing the display.

In an embodiment the game is conducted over a mobile phone network and wherein the player terminals are portable computing devices implementing the display.

In an embodiment the game is conducted over a wide area network and wherein the player terminals are kiosks.

In accordance with a fourth aspect there is provided a gaming system comprising:
a draw management module operable to implement a draw in which randomly selected symbols from a triangular number of symbols are allocated to players until each of the symbols have been allocated, the symbols being allocated responsive to receiving player wagers of a first predefined value;
a selector apparatus providing physical objects representative of respective ones of the symbols, the apparatus further arranged to randomly select one of the physical objects such that the symbol for which it represents is determined to be a winning symbol; and
an award module operable to award a prize to a player in the draw having been allocated the winning symbol, the award being funded from the received player wagers.

In accordance with a fifth aspect there is provided a method of determining an outcome of a wager game, the method comprising:
populating a triangular shaped receptacle with a set of balls, each of the balls having a unique symbol displayed thereon;
rotating the triangular shaped receptacle for a period of time such chat at the end of the rotation a vertex thereof stops at a winning symbol position; and
determining the symbol displayed on the ball which is located closest to the winning symbol position to be the winning symbol for the game.

In an embodiment the set comprises a triangular number of balls with each of the triangular number of balls being distributed evenly within the triangular shaped receptacle.

In an embodiment the triangular shaped receptacle has an equilateral wall profile.

In an embodiment the triangular shaped receptacle is rotated about an axis which extends through its centroid.

In an embodiment the step of populating the triangular shaped receptacle comprises displaying the balls entering the triangular shaped receptacle in a random manner.

In accordance with a sixth aspect there is provided a method of conducting a game comprising:
allocated randomly selected symbols from a symbol set to players until each of the symbols in the symbol set have been allocated, the symbols being allocated responsive to receiving player wagers of a set value;
randomly determining one of the symbols in the symbol set to be a winning symbol;
awarding a prize to a player having been allocated the winning symbol; and
automatically allocating the player a randomly selected symbol for a subsequent play of the game, the automatically allocated symbol being funded from the recerved player wagers for the current draw.

In accordance with a seventh aspect there is provided a method of conducting a wager game, the method comprising:
displaying a triangular number of symbols on a game table in a grouping;
allowing players to place a wager on a displayed symbol;
randomly determining one of the symbols to be a winning symbol; and
awarding a price to players who have placed a wager on the winning symbol.

In an embodiment the triangular number is at least six. In an embodiment, where the triangular number of symbols is n, the odds paid are 1−n times the wager.

In an embodiment the symbols are displayed in a triangular grouping.

In an embodiment the method further comprises allowing players to place a wager on a grouping of at least two but not all of the displayed symbols, the grouping of symbols being associated with one of the vertexes of the triangle.

In an embodiment the method further comprises allowing players to place a wager on a grouping of at least two Out not all symbols being associated with a central region of the triangle.

In accordance with an eighth aspect, the present invention provides a gaming system for providing play of a wager game, the system comprising:
a table for displaying a triangular number of symbols in corresponding symbol positions, each position operable to receive at least one marker representative of a player wager; and
a draw apparatus for randomly determining one of the displayable symbols to be a winning symbol, such that a prize is awarded to players who have placed a wager on the corresponding winning symbol position.

In accordance with a tenth aspect there is provided a method of conducting a wager game comprising:
allowing a player to place individual game wagers across a plurality of games to be played in the wager game;
implementing a common draw phase in which a plurality of symbols are randomly drawn from a symbol draw set to determine outcomes of the plurality of games, such that at least one of the drawn symbols is used for determining, at least in part, the outcome for each of the plurality of individual games.

In an embodiment each of the games is played on a common game layout.

In an embodiment the common game layout is a triangular game board populated with a triangular number of symbols corresponding to symbols available for selection from the draw set.

In an embodiment the triangular number is 32.

In an embodiment the method further comprises allowing the player to select the individual games to play from a set of selectable games.

In an embodiment at least one of the individual games is a matching game whereby drawn symbols are matched against symbols on a player game card and prizes awarded for completing triangular patterns on the game card.

In an embodiment the individual games are played in sequence.

In an embodiment the individual games are played concurrently.

In an embodiment individual subsets of the drawn symbols are utilised for determining outcomes for the respective games.

In an embodiment individual subsets of symbols are distinctly marked.

In an embodiment the first drawn subset of symbols is utilised, at least in part, for determining the outcomes for each of the plurality of individual games.

In an embodiment the individual games are selected from the group comprising: modified keno, modified bingo and modified roulette.

In an embodiment the method further comprises implementing the wager game as a muitiplayer game whereby the common draw phase is used for determining the outcomes for all player wagers placed across individual games.

In accordance with an eleventh aspect there is provided as gaming apparatus for conducting a wager game comprising:
a player terminal for allowing a player to place individual game wagers across a plurality of games;
a game controller for implementing a common draw phase in which a plurality of symbols are randomly drawn from a symbol set to determine outcomes of the plurality of games, such that at least one of the drawn symbols is used for determining, at least in part, the outcome for each of the plurality of individual games.

In accordance with a twelfth aspect there is provided a method of conducting a roulette style wager game, comprising:
providing a wager space comprising a triangular number of symbols presented in a triangular grouping, the symbols presented in the triangular grouping corresponding to symbols in a draw set;
allowing a player to place a single symbol wager relating to a single drawn symbol;
allowing a player to place a combined symbol wager relating to a combination of drawn symbols; and
implementing a draw phase in which a plurality of symbols are randomly selected from the draw set, such that a first subset of the drawn symbols is used to determine the outcome of the single symbol wager and a second subset of drawn symbols is used to determine the outcome of the combined symbol wager.

In an embodiment the first subset of symbols comprises the first drawn symbol and the second subset of symbols comprises all of the drawn symbols.

In an embodiment the first subset of symbols comprises the first drawn symbol and the second subset of symbols comprises the remainder of the drawn symbols.

In an embodiment the number of drawn symbols is 3.

In an embodiment the method further comprises implementing the draw phase using a roulette wheel having individual pockets associated with respective ones of the symbols in the draw set.

In accordance with a thirteenth aspect there is provided a game apparatus comprising:
a wager space comprising a triangular number of symbols presented in a triangular grouping, the symbols presented in the triangular grouping corresponding to symbols in a draw set;
a wager module operable to receive from a player (i) a single symbol wager relating to a single drawn symbol; and (ii) a combined symbol wager relating to a combination of drawn symbols; and
a draw apparatus operable to implement a draw phase in which a plurality of symbols are randomly selected from the draw set, such that a first subset of the drawn symbols is used to determine the outcome of the single symbol wager and a second subset of drawn symbols is used to determine the outcome of the combined symbol wager.

In accordance with a fourteenth aspect there is provided a computer readable medium storing computer program code which is operable to implement the method in accordance with any one of the afore-described aspects.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic block diagram of a gaming system, according to an embodiment of the present invention;

FIG. 2 is a schematic block diagram of operative components of a game controller of the gaming system, according to an embodiment;

FIG. 3 is a representation of an example player game card;

FIG. 4 is a screen shot of a display showing an outcome of a draw, in accordance with an embodiment;

FIG. 5 is a screen shot of an example animation sequence for a game outcome;

FIG. 6 is a flowchart of an embodiment;

FIG. 7 is a schematic block diagram of a gaming system, according to an alternative embodiment of the present invention;

FIG. 8 is a plan view of a gaming table, in accordance with an embodiment;

FIG. 9 is a schematic of the gaming table of FIG. 8 in association with a draw arrangement, in accordance with an embodiment;

FIG. 10 is an illustration of a wager space for playing a roulette style game, in accordance with an embodiment;

FIG. 11 is schematic of a multi-terminal gaming system for implementing a multigame in accordance with a particular embodiment;

FIG. 12 shows an example pay cable for a bingo style game, in accordance with an embodiment;

FIGS. 13a through 13d are example screen shots of different winning patterns for a bingo style game implemented by the gaming system of FIG. 11, in accordance with an embodiment; and

FIG. 14 is a table showing example player wager and draw selections for a rnaitigame embodiment of the present invention.

### DETAILED DESCRIPTION

Embodiments described herein relate to wager games. In a particular embodiment, a draw of the game comprises allocated players randomly selecting symbols from a symbol set. The symbol set comprises a triangular number of symbols, such that the symbols are allocated responsive to receiving individual player wagers of a fixed value. One of the symbols in the symbol set is randomly determined to be a prize winning symbol and the player who was allocated the randomly determined prize winning symbol is awarded a prize, which is funded from the received player wagers for that draw. In certain embodiments, once all of the symbols have been allocated, further draws can be opened and concurrently played such that each game can include multiple winners from different draws. Games are commenced periodically ana preferably on a frequent basis, such as every few minutes (in much the same manner as a typical keno style game).

General Construction of Gaining System

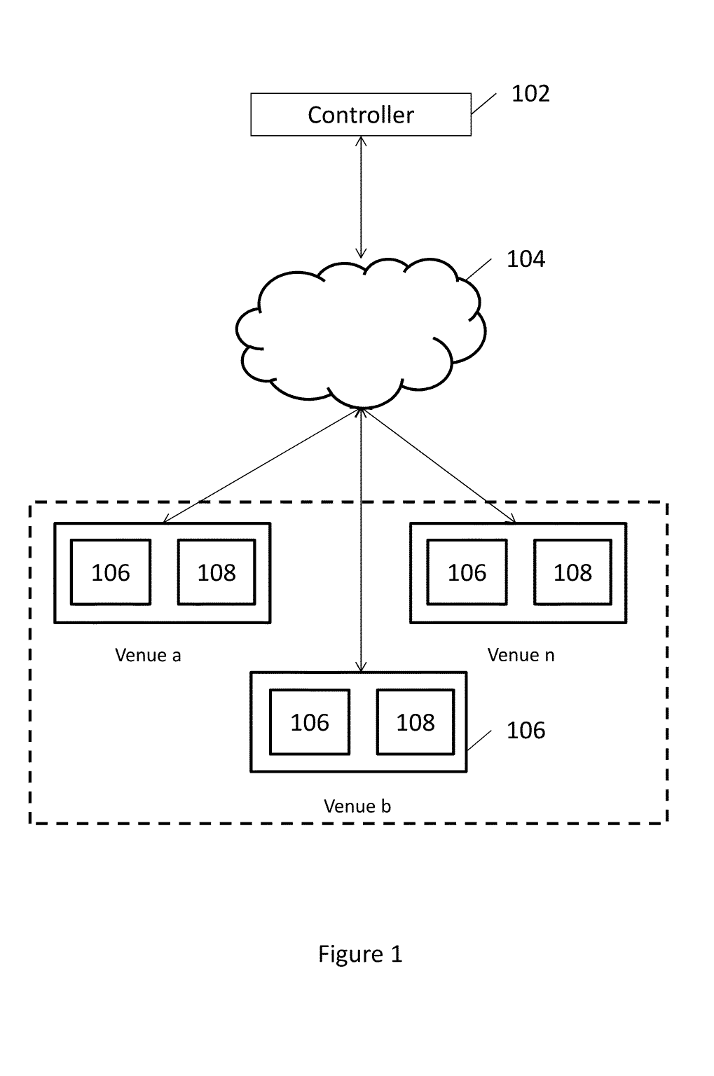

The gaming system for implementing embodiments can take a number of different forms. For a particular ‘lottery style’ embodiment as described herein, and with reference to FIG. 1, the system 100 takes the form of a distributed architecture whereby a centralised game controller 102 communicates over a communications network 104 with one or more remotely located player terminals 106 and display screens 108. The player terminals 106 and display screens 108 may, for example, be located within venues such as hotels, clubs, casinos, or any suitable venue. It will be understood that the display screens 108, whose primary function is to display the winning prise symbol for each draw (although they may also be used to display other representations, for example promotional or informational material), could be integrated directly into the terminals 106 or provided independently thereof, such as wall mounted within the venues. The communications network 104 may be any suitable network although in the embodiment described herein is in the form of a wide area network (WAN). It will be appreciated that the WAN may be wired, wireless, terrestrial, satellite based or the like. Preferably a secure communications link is implemented to prevent unauthorised communication.

Player Terminals and Displays

In more detail, the player terminals 106 of the illustrated embodiment are in the form of kiosks located in authorised venues such as restaurants, casinos, clubs, hotels or the like. The kiosks 106 may, for example, be self-serve kiosks 106 including the necessary computer hardware and software for receiving player draw entries and issuing tickets for purchased draws. The kiosks may also be capable of paying out prizes for winning tickets. Various networking hardware and software is also provided for communicating with the game controller 102 over the WAN network 104, as will be understood by persons skilled in the art.

Entries into draws are made by completing a player game card and paying the appropriate entry fee (referred to hereafter as wager). The player game card may be a physical card or a virtual card. According to the illustrated embodiment, the player game card is a virtual card which the player completes using a touch screen display 110 implemented by the kiosk 106.

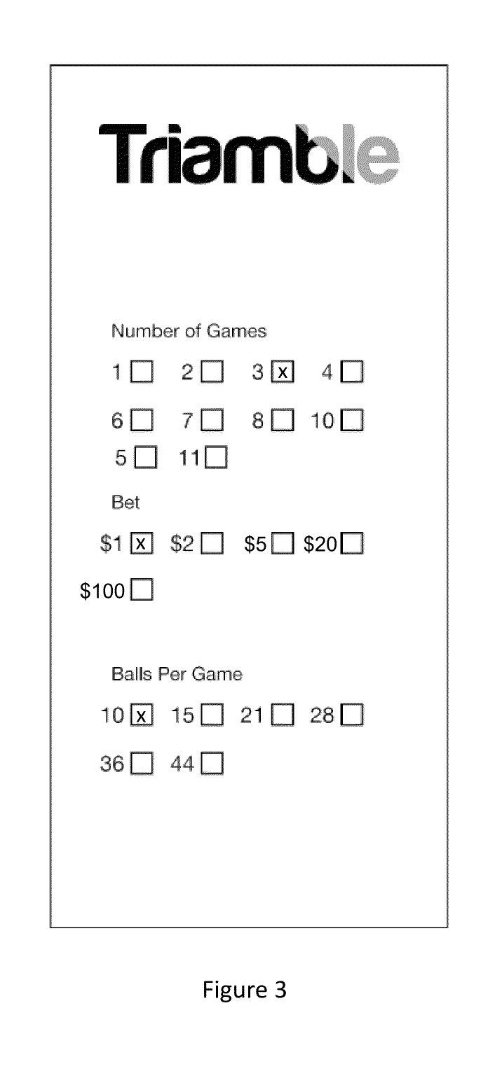

An example virtual game card shown in FIG. 3. Completing the card comprises selecting which tier (or tiers) of a draw to play, as well as the number of games to play for the selected tier(s). In the illustrated embodiment, there are five tiers having distinct predefined entry wagers ranging from $1 to $100 (i.e. such that the tier level corresponds to the predefined wager entry value), although it will be understood that a greater or lesser number of tiers of any particular entry wager value could be playable depending on the desired implementation. According to FIG. 3, the player has elected to play a $1 draw for three consecutive games.

Once the card has been completed and the appropriate money paid (in this case $3), the kiosk 106 sends an entry request, which includes the completed game card information, to the game controller 102. As will be described in more detail in subsequent paragraphs, the controller 102 processes the request and allocates the player a randomly selected symbol for each purchased draw. The symbol is randomly selected from a symbol set comprising a triangular number of at least six symbols, in order to yield she desired odds and probabilities for the game described herein. The triangular numbers are given by equation (1) below, where n must necessarily be three or more to satisfy the condition that the symbol set contains at least ten symbols:

$${T}_{n} = {\sum }_{k = 2}^{n} k = 1 + 2 + 3 + … - n = \frac{n ( n + 1 )}{2} \qquad Equation ( 1 )$$

The associated odds and probabilities for a few different triangular number games are provided in the table 1 below.

TABLE 1

| No. Symbols Played | Odds (Times) | Probability (%) |
|---|---|---|
| 10 | 8 | 10 |
| 15 | 13 | 6.6 |
| 21 | 19 | 4.7 |
| 28 | 26 | 3.5 |
| 36 | 34 | 2.77 |

According to the presently described embodiment the game is a 10 symbol game with the symbols taking the form of balls numbered from 1 to 10 inclusive (although it will be understood that other unique symbols such as letters, playing card symbols, fruit symbols and the like could equally be played).

A confirmation is sent back to the kiosk 106 which is representative of the draw allocation information including the player allocated numbers for the purchased draws (this process is described in more detail in subsequent paragraphs). The confirmation is processed by the kiosk 106 and a ticket printer prints a ticket displaying the player allocated balls as well as encoded draw information for redemption and validation purposes, as will be well understood by persons skilled in the art. A ticket reader may also be provided for reading the encoded information on the ticket which is sent back to the controller 102 for paying out prizes.

The Game Controller

The game controller 102 is implemented by an operator of the game. According to the illustrated embodiment, the game controller 102 is part of a computer server system which is in data communication with both the player kiosks 106 and displays 108. The controller 102 is generally responsible for generating and confirming valid entries (as discussed above), as well as determining game outcomes for displaying on the various display screens 108. The game controller also functions to manage prize pools for each draw, in accordance with distribution rules. In particular embodiments the game controller 102 is further arranged to award a jackpot prize in accordance with jackpot prize awarding rules. The various rules are stored as program code in a memory but can equally be hardwired depending on the desired implementation.

The game controller 102 includes a processor which is arranged to carry out the aforementioned functionality. Herein the term “processor” is used to refer generically to any device that can process instructions in accordance with certain game related rules and may include: a microprocessor, microcontroller, programmable logic device or other computational device, a general purpose computer (e.g. a PC) or a server.

Further Detail of the Game Controller

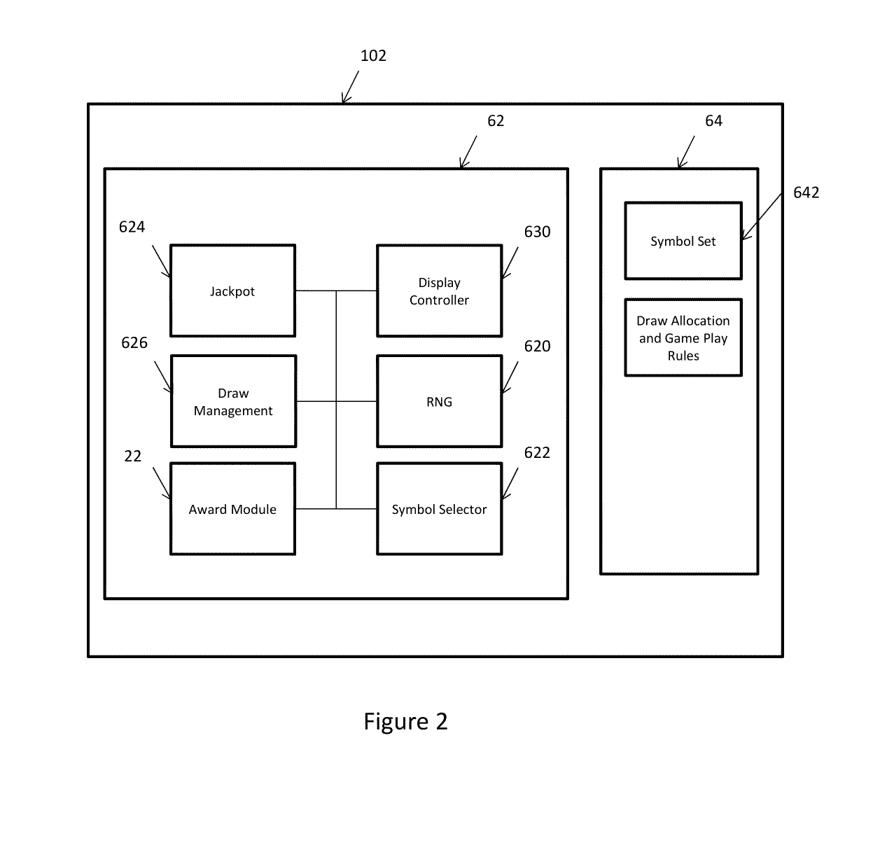

It will be apparent that the processor 62 implements a number of modules to achieve the aforementioned functionality. With particular reference to FIG. 2, those modules include a random number generator module 620, symbol selector module 622, jackpot module 624, draw management module 626, award module 628 and display controller module 630, based on program code stored in memory 64. The set of symbols playable in the game (in this case numbered balls) is also stored in memory in a symbol store 642.

The processor 62 receives draw entries (as afore-described) and with the aid of the symbol selector module 622 allocates randomly selected balls to players. In response to having allocated ail of the balls for a draw in a particular tier, the draw management module 626 is operable to open a new draw of the same tier level (hereafter each draw in a particular tier will be referred to as a ‘flight’) and the symbol allocation process repeats. The same methodology for allocating balls and creating new flights takes place for each draw tier, such that for any one game there may be multiple winners across the same or different tiers who have been allocated the same prise winning ball by the symbol selector module 622. Allocation of numbered balls and creation of new flights continues until a countdown has expired for that particular game, at which time the prize winning ball is randomly determined by the symbol selector module 622 with the aid of the RNG 620. Any unfilled flights at this point (i.e. flights where some but not all ball in the symbol set have been allocated to players) are held over to the next game. Hereafter the term “seats” will be used to describe the entries in each flight.

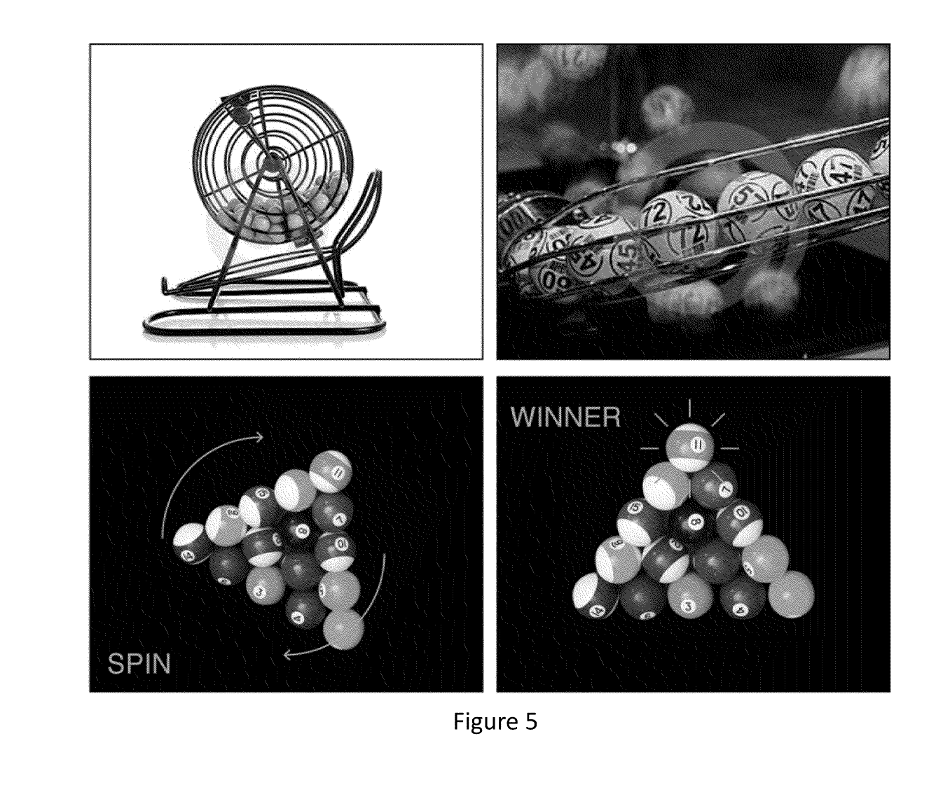

The display controller module 630 causes the operable displays 108 to display a representation of the game and the resultant winning ball for each game. With reference to FIG. 5, each display 108 is controlled to display various relevant game and draw information including the current game number 120, no of flights currently filled 122, time to the next game 124, number of players per jackpot level 126 (discussed in more detail in subsequent paragraphs), the number of seats left for the flight being currently filled for each tier level 128 and the current jackpot prize value 129.

A representation of the draw outcome is also displayed on the respective displays 108. According to the illustrated embodiment, after the countdown has elapsed, the outcome involves an animation sequence (see FIG. 5) which is played showing the balls being randomly released and falling into a triangular matrix 130, with the prize winning ball shown in one of the three vertexes (see slides 1 and 2). At slide 3 the animation sequence snows the receptacle 130 being rotated or spun (e.g. like a chocolate wheel or roulette wheel) and coming to rest with the winning ball being displayed at a prize winning location (in this case at the top of the screen). The prize winning ball is also displayed next to the text “WINNER!” as a further visual indication to the player. As will be appreciated the animation sequence may heighten player anticipation, since players having been allocated balls in any one of the three vertexes will wait expectantly to see if their ball ends up in the prize winning location. Players having been allocated winning balls may then present their winning ticket at the kiosk 106 for prize redemption. It will be understood that the above sequence may be implemented in a physical ‘live’ form whereby a triangular receptacle is used to contain the balls. The receptacle may, for example, have an equilateral wall profile with the balls being distributed evenly therein. The receptacle may be rotated by a motor such that it rotates about an axis extending though the centroid of the triangular receptacle (again rotating for some predefined or randomly determined period of timte). The balls may enter the receptacle at random from a basket in much the same manner as described above for the video animation.

Paying Prizes

In the illustrated embodiment, players with a winning ball are not only paid a prize but are also awarded a free entry into the next game (of equal tier wager value). For higher paying draw tiers, such as, for example, the $100 draw tier, winning players may not be awarded an automatic entry in the next round and instead simply receive greater odds. It will be appreciated that the threshold for determining whether or not the automatic entry will apply can vary depending on the odds specified by the lottery operator.

In order to achieve the above functionality, the draw management module 626 maintains a separate prize pool for each flight. Each pool is made up of wagers payed by players who have been allocated balls for that particular flight. For example, a filled flight in the $1 draw tier would have a $10 price pool value. A portion of the prise pool is allocated to funding the respective player prize. Another portion is allocated to funding the automatic entry into the next draw for the winning player, if applicable. The remaining portion is paid to the house.

According to illustrated embodiment, the portioning is as follows for the $1, $2, $5 and $20 games, where n is the number of symbols in the symbol set:

prize Value: n−2/n×accumulated received wager value House Takings: 1/n×accumulated received wager value Funding of entry into subsequent draw: 1/n×accumulated received wager value

For the $100 game, where there is no automatic next game entry, the portioning is as follows;

Prize Value: n−1/n x accumulated received wager value House Takings: 1/n x accumulated received wager value

The award module 628 is responsible for awarding the prizes to players responsive to a valid ticket being presented to the player kiosk 106.

Jackpots

Where a player has won a set number of games in a row they may be awarded a jackpot prize (in addition to the normal prizes awarded up to that point). The prize may be funded from a portion of house takings (e.g. 10% of all house takings for a particular day) which is held in a jackpot prize pool controlled by the draw management module 626. For example, players may be required to have won six straight games (i.e. of which they nave been automatically entered into five without requiring payment of a wager) in order to be awarded the jackpot prize. It will be understood chat the set number of games as well as the way in which the prize pool is funded may vary depending on one desired implementation and should not be seen as being limited to the example given above.

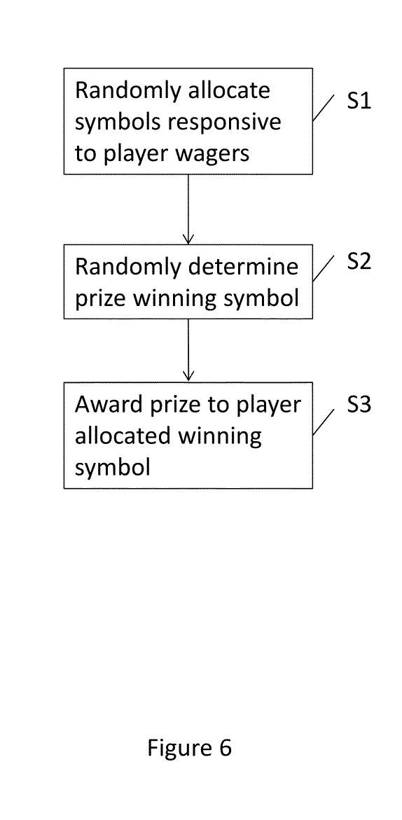

A method for implementing a particular draw of the game is summarised in FIG. 6. The method comprises randomly allocating balls to players responsive to receiving the relevant player wager, until all balls have been allocated (step S1). At step S2 one of the balls is randomly determined to be a winning ball. A prize is subsequently awarded to the player having been allocated the winning ball at step S3.

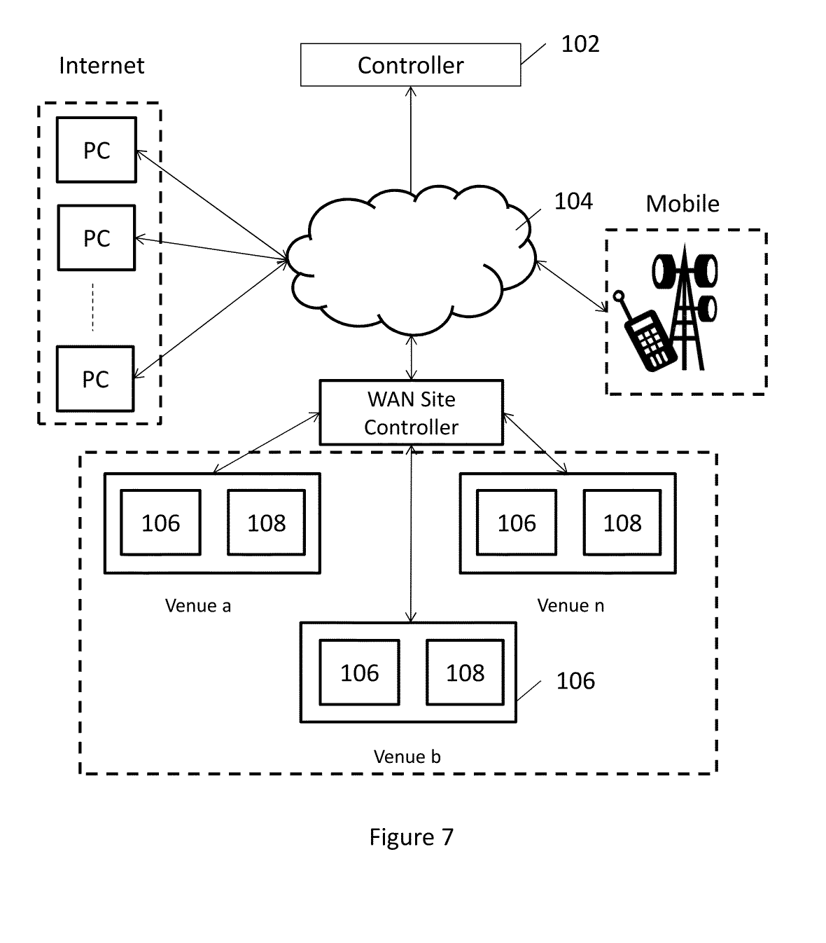

Although the afore-described embodiments were described in the context of a venue based game it will be understood that alternative embodiments may involve players remotely participating in the game. For example, the controller 102 could be configured to communicate over any suitable network such as an intranet, and/or to gaming systems provided through computing or other electronic devices, e.g. personal computers, PDAs, mobile telephones, digital televisions, and the like, e.g. over the Internet or other suitable communications networks. This is best shown in FIG. 7, whereby the controller 102 is provided with the necessary software and hardware for controlling game play over three different mediums at the same time. Thus, players can enter a draw either using their mobile phone, network-connected computer or at a kiosk located in a gaming venue. It will be understood that the controller 102 may be configured to implemented separate games for each medium depending on the desired configuration.

Casino Implementation

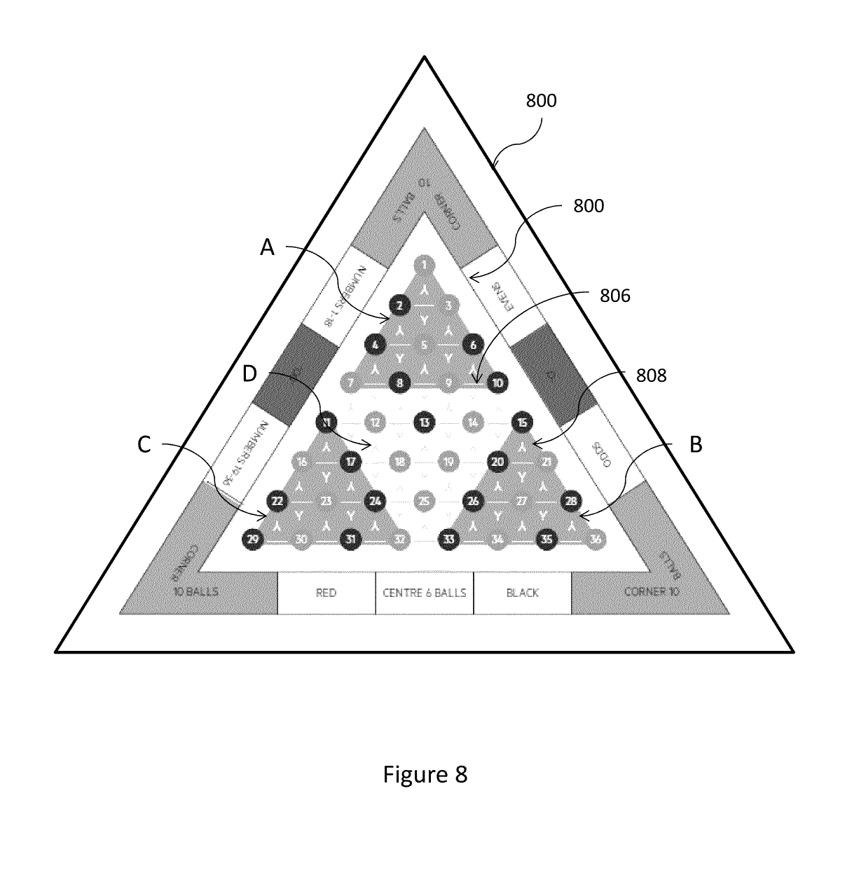

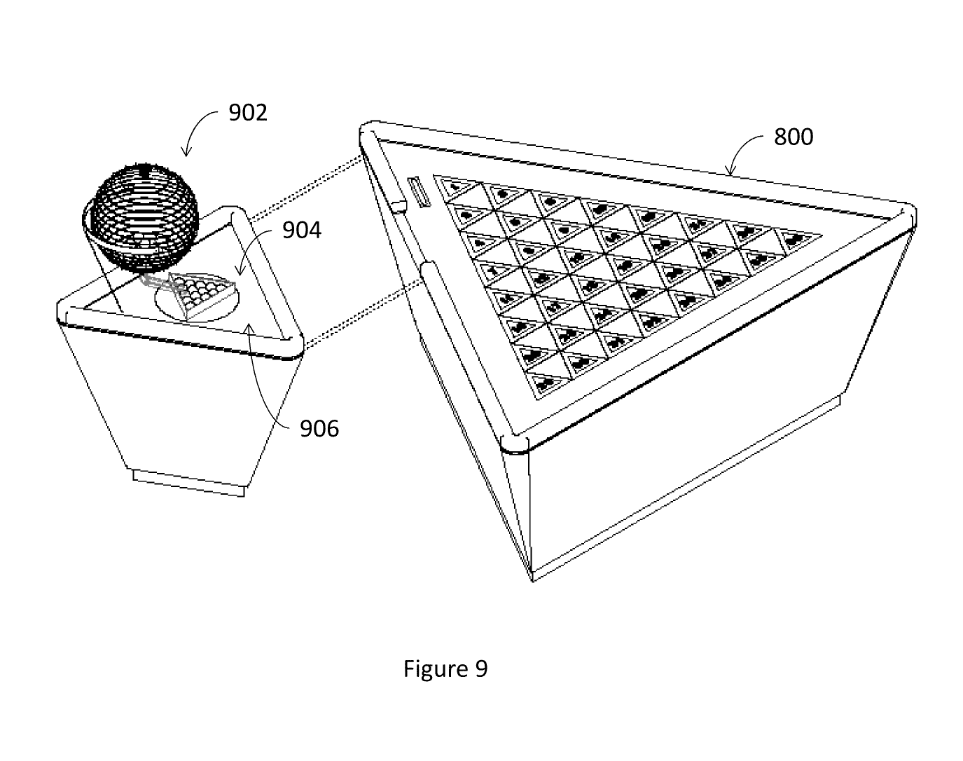

A table game embodiment which is particularly suited for a casino implementation will now be described with reference to FIGS. 8 and 9. According to such an embodiment a physical gameplay table 800 provides a wager surface on which is displayed a triangular grouping of a triangular number of symbols (hereafter a “triangular wager layout”), as particularly shown in FIG. 8. As for the previous embodiments, the symbols may take on any form but the triangular wager layout must comprise at least six symbols. According to the embodiment illustrated in FIG. 8, the triangular wager layout displays symbols in the form of numbered balls ranging from 1 to 36 which are alternatively coloured red and black. The balls are located within symbol spaces which are evenly distributed within an equilateral triangular border 804 of the triangular wager layout. During a wager phase, players are allowed to place wagers on a particular ball or selection of balls, in much the same manner as a roulette game. Once the wager phase has ended (e.g. once all players have finished placing their wager, or after some period of time determined by the gaming attendant), one of the numbered balls is randomly determined to be the winning ball through a random number draw. In this example embodiment the draw set (from which the numbered bails can be selected; consists of 36 numbered bails, as well as “0” and “00” house balls. Thus, the draw set for the illustrated embodiment consists of 38 selectable balls. Players who have placed wagers on the randomly drawn ball are subsequently paid a prize.

More particularly, players can place a wager on a single numbered ball by placing a chip directly on a desired number in an inner zone of the triangular layout. Split two or three numbered ball wagers can be placed through placing a chip on either the horizontal line marker 806 or tripod marker 808 respectively. An outer zone of the triangle can be used for placing colour, odds/even, “0”, ‘00’, number range or pattern bets. With regards to the pattern bets, players can place a wager that the drawn ball will be in a particular triangular grouping. In this particular example, players can wager that the drawn ball will be located either in any one of the 10 ball corner groupings (A, B or C) or within a 6 ball middle grouping (D). The odds associated with each grouping will vary depending on parameters such as the number of balls within the grouping, the number of selectable draw balls, the house edge, etc. However, according to one example for the 36 ball embodiment shown in FIG. 8, the odds are as follows:

| Grouping Played | Odds Paid | Probability (%) |
|---|---|---|
| Grouping A, B or C | 3 to 1 | 27.7 |
| Grouping D | 2 to 1 | 16.6 |

With reference to FIG. 9, there is shown a draw arrangement 902 for determining a winning ball in accordance with an embodiment. The draw arrangement 902 comprises a mechanised ball drawing tumbler 904 which is capable of receiving solid rubber balls. The tumbler 904 is filled with balls each marked with a number and colour corresponding to a numbered/coloured ball selectable on the game table 800. At the beginning of the draw phase, the tumbler 904 is rotated for a period of time to mix the balls before they are sequentially released down a tube and into a triangular rack 904. Once the rack 904 has been filled, the rack 904 is rotated on a mechanised turntable for a period of time before coming to rest such that one of the vertices of the rack 904 is aligned with a prize maker 906. The number displayed on the ball which is located on the aligned vertex is determined to be the winning number. An electronic display screen viewable by each of the players may also display the winning number (e.g. by way of a video feed). In an alternative embodiment, the ball determination may be carried out electronically such that the mechanised draw arrangement 902 is not required. For example, the electronic determination may be made in the same manner as previously described with reference to FIG. 5. Yet another alternative draw technique may involve temporarily illuminating symbol spaces 302 on the wager layout at random and ending with the space for the winning number being persistently lit. Yet another embodiment may involve using a roulette wheel to determine a number and colour of the ball, using techniques well understood in the art. It will be understood that any suitable technique could be adopted for informing players and attendants of the winning number/colour.

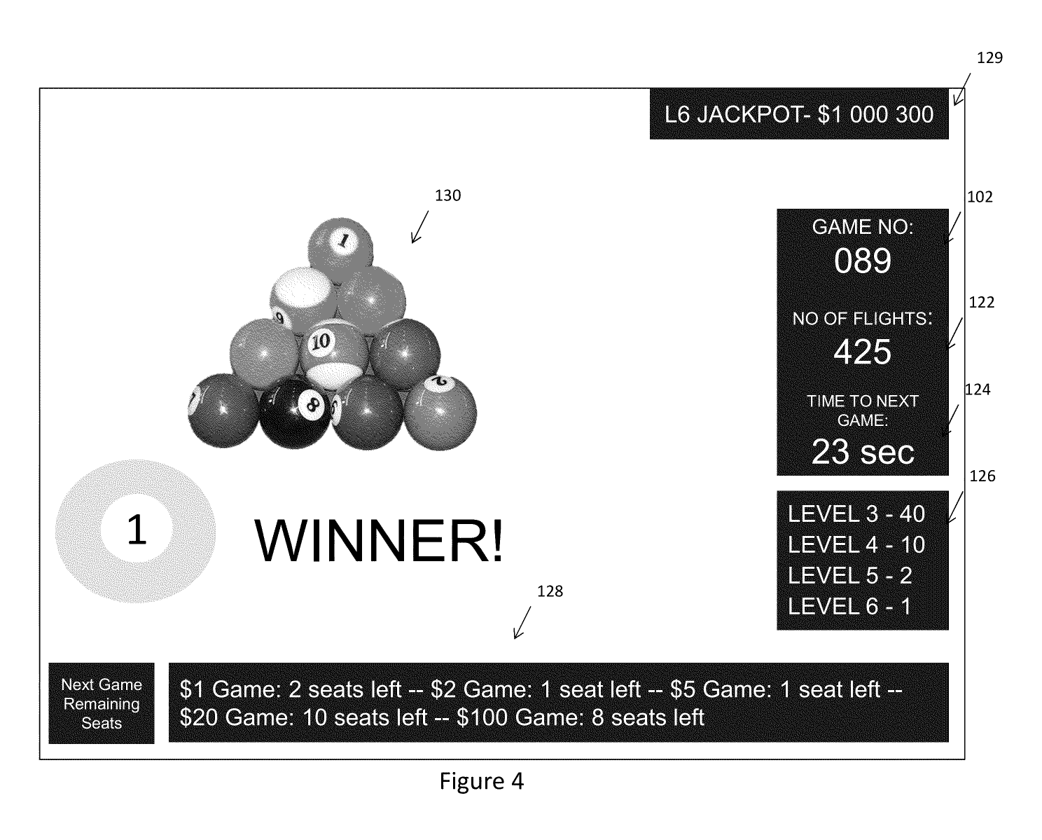

It will be understood that for the above casino style embodiment not all numbers need to be played before a draw is commenced (as for the embodiments described with reference to FIGS. 1 to 7). Instead, according to this scenario, the house funds the player returns and consequently takes on the risk for each game. Thus, it will be understood that the odds may vary depending on the desired implementation ana the payout structure provided by the casino. According to one example implementation for the 38 ball embodiment illustrated in FIG. 8, the payout for a straight up bet are 35 to 1 with the odds against winning being 37 to 1 (i.e. so as to provide a house edge). It will also be understood that the casino style implementation could be played with or without the “0” and “00” symbols and that the number of symbols in the triangular layout and corresponding draw set could comprise either a greater or fewer number of wagerable symbols.

A further table game embodiment, referred to herein as a “roulette derivative”, allows prayers to place single ball wagers as generally described above (i.e. straight up, odds/evens, colours, number groupings, etc.), as well as a combined ball wager for achieving specific ball combinations within the triangular wager space. The winning ball numbers/colours for establishing wager outcomes are determined through a multiple ball draw. In the presently described embodiment, the multiple ball draw is carried out utilising a roulette wheel.

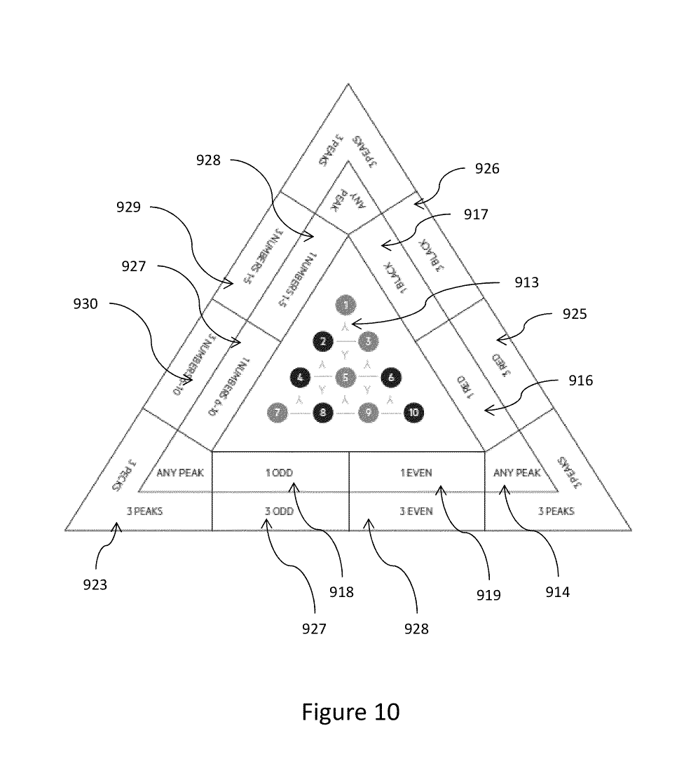

To illustrate the roulette derivative game, and with additional reference to FIG. 10, a “10 ball” roulette derivative game is contemplated. Players place wagers on a triangular wager layout 911 (in this instance being an equilateral triangular layout) presented on a physical gaming table. The triangular layout is populated with reb and black coloured balls numbered 1 through 10. As mentioned above, a roulette wheel (not shown) is used for determining winning balls and accordingly consists of 10 coloured and numbered pockets (corresponding to the numbered and coloured balls in the triangular wager space). Single ball wagers are placed in an inner zone of the triangular wager space and for this game may consist of any one of the following wager types:
a) Match a single numbered ball
b) Match one of two split balls
c) Match one of three split balls in triangular grouping
d) Match any of the balls located at triangle vertices (referred to herein as “peak” bets)
e) Match any one of five red balls
f) Match any one of five black balls
g) Match any one of five even balls
h) Match any one of five odd balls
i) Match any one ball numbered 1 to 5
j) Match any one bail numbered 6 to 10

Players make the single ball wagers by placing a chip on a single number (i.e. for bet (a)) or on a desired inner-zone segment as described below:
Splitting two bails as per bet (b)—place chip on “-” marker (912) displayed between adjoining balls
Splitting three bails as per bet (c)—place chip on tripod marker (913) displayed between bails in desired triangular grouping
Any peak as per bet (d)—place chip directly onto any peak cone bet (914)
Red or Black bail as per bets (e) and (f)—directly onto the relevant colour zone bet (916, 917)
Odd or even ball as per bets (g) and (h)—directly onto the odds/evens zone bet (918, 919)

1 Numbers 1-5 or 6-10 as per bets (l) and (j)—directly onto the relevant group number zone (920, 921).

According to the illustrated embodiment, three “draw” balls (unrelated to the numbered and coloured balls that can be wagered on by players) are spun in a roulette wheel to determine outcomes of both the single and combined ball wagers. The first draw ball is used to determine the single ball wager, while the second and third draw ball (together with the first draw ball) determine the outcome of the combined ball wager. The first draw ball may be marked differently to the second and third draw balls to assist players in understanding which wager the balls relate to. It will be understood that it is not necessary that a physical roulette wheel be used for determining the winning ball numbers/colours and that this selection process could equally be carried out using a RNG with the resultant numbers displayed on a display screen. It will also be understood that more than three draw balls could be utilised to determine combine ball wagers depending on the size of the triangular layout, patterns available and game mathematics. For the three draw ball embodiment shown in FIG. 10, the pattern wagers selectable by the player include:

k) Match all numbered balls in a particular corner ball sub triangle;

l) Match all of the peak balls;

m) Match all balls are either red or black

n) Match all balls are either odd or even

o) Match all balls are numbered in either 1-5 or 6-10 grouping

To make a combined ball wager, players place their chips on the relevant segment in the outer zone of the triangular wager space, as described below:
Match specific three ball corner sub triangles as per bet (k)—chip placed directly onto the relevant corner cone bet segment (922)
Match all peaks as per bet (l)—chip placed drrectly onto any one; of the all peak zone bet segments (923)
Match all balls are red or black as per bet (m)—chip placed directly onto the relevant coloured zone bet segment (925, 926)
Match all balls are odd or even as per bet (n)—chip placed directly onto the relevant odds/evens zone bet segment (927, 928)
Match all balls in either 1-5 or 6-10 grouping as per bet (o)—chip placed directly onto the relevant grouping zone bet segment (929, 930)

Once the wagers have been placed, the croupier spins the roulette wheel for each draw ball. Once the three draw balls have come to rest (i.e. received in numbered/coloured pockets of the roulette wheel), the croupier calls the results of the first draw ball number & colour, followed by the second and third draw ball numbers & colours. The croupier then places distinctly marked dollies on the winning numbers on the triangle wager space, clears loosing bets & pays out winning bets.

It will be understood that the above described roulette derivative game should not be seen as being limited for play on a physical casino table ana instead could readily be implemented as a screen based game, e.g. playable on an electronic gaming machine EGM, as an Internet-based game or the like. In this regard an electronic game controller, such as the game controller 102 as afore-described with reference to FIG. 1, may be used to receive player wagers, control game play and award winning pays.

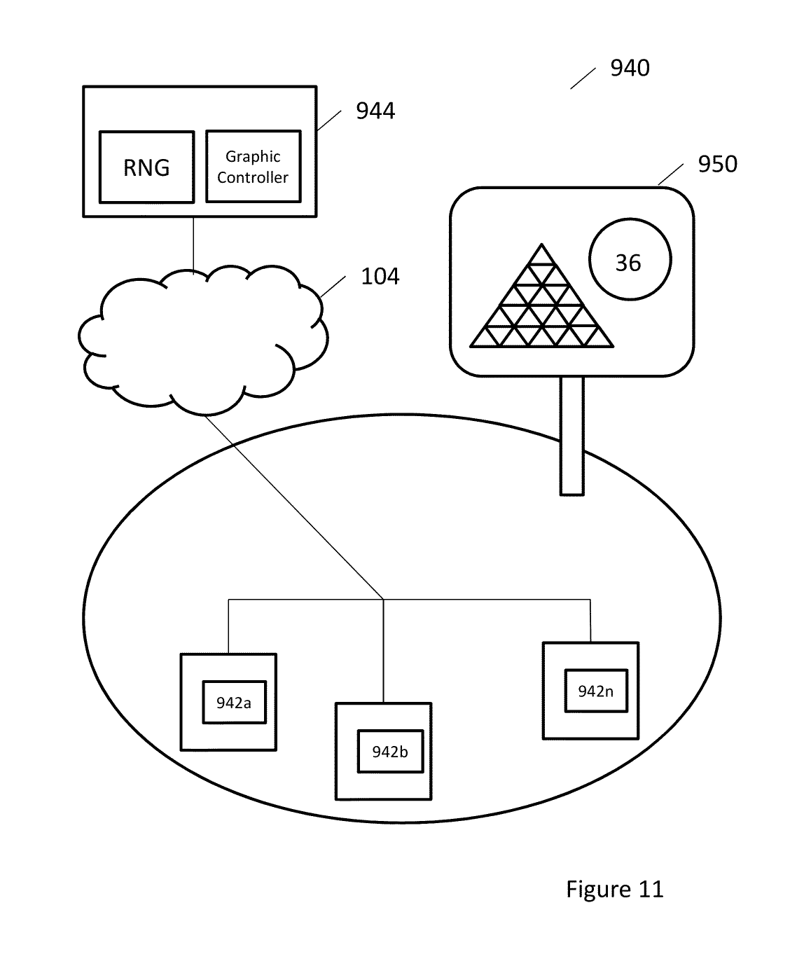

FIG. 11 is a diagram of a system 940 particularly suited for implementing a multigame variant of the present invention. Using the system of FIG. 11 players can select a number of different triangular based wager games for sequential or concurrent play, with the respective game outcomes being determined based on a selection of symbols drawn in a single common draw phase.

The system 940 includes a plurality of individual player terminals 942a through 942n which each provide a user interface for allowing players to select their games, make game specific wagers (including making symbol/ball/number selections) and to review prise tables, play instructions, etc. Each of the terminals 942 are connected to a central controller 944 over a communications network 104 in the form of a WAN. The central controller 944, which incorporates the same functional modules as the controller 102 of FIG. 1, receives the player game selections and wagers and controls subsequent game play. A central display 950 is commune cable with the central controller 944 and is visible to players of each terminal 942 for displaying the outcomes for the staged draw phases.

According to embodiments described herein, each of the wager games that are selectable for play on the respective terminals 942 are played on a triangular wager space, much the same as described for the casino style games previously described with reference to FIGS. 8 through 10. The games described herein take the form of modified keno, modified bingo ana modified roulette, as will be described below in more detail. It will be understood, however, that other triangular based games could equally be played as part of the multigame variant, depending only on the desired implementation. Further, it will be understood that the multigame variant could be played across a plurality of inter-connected EGMs (using networked configurations as are well understood in the art) as opposed to on a multi terminal gaming machine as shown in FIG. 11.

Multigame Example

In this example, the staged draw phase takes the form of a common draw sequence with different drawn symbols (in this case being numbered and coloured balls as previously described) being used to determine the outcomes of the different games played on the player terminals 942. In a first step, players select the individual games they wish to place wagers on from a game menu. In this example, players can choose to play either a two game sequence consisting of modified roulette and modified keno, or a three game sequence additionally consisting of a modified keno game. It will be understood that the sequence could consist of any number of games (selected from the game menu), depending only on the desired implementation. In this example, the draw set consists of 36 numbered and coloured balls which are randomly selected in the common draw sequence.

The first game in either the two or three game sequence is a modified roulette game which takes the same form as for the roulette style wager game as previously described with reference to FIG. 8, but without the ‘0’ and ‘00’ wager options. It will be understood that the number of symbols in the triangular wager space may vary depending on the desired game mathematics and popularity, but according to this embodiment consists of 36 space triangle populated with numbered and coloured balls (i.e. corresponding to the bails in the draw set). Players make the wagers by placing chips directly on to the relevant number or zones bets marked on triangular wager space presented on the user interface of the player terminals 942. The user interface may include appropriate circuitry to recognise the placement of a physical chip on a particular numbered ball or zone (e.g. using RFID, etc.), or alternatively the symbol selection may be carried out through making a selection on their game terminal (e.g. using a touch screen, buttons, etc.).

Once the roulette selections have been made, the player is presented with a further screen for making their keno style selections. This requires the player to select balls for completing the keno wager. The keno selections are made in independence of the roulette selection (i.e. such that the player may or may not decide to select the same ball as for the roulette game) and are made by choosing their balls on the same triangular wager layout as for the roulette game. The modified keno wager options are much the same as for regular keno, with the player required to select the number of credits wagered per ball, number of games to be played, etc. The maximum number of keno balls that are available for selection by the player in this example embodiment is 5, with 10 balls in total being drawn to determine keno outcomes. However, it will be understood that the number of balls selectable and drawn in the keno style game may vary with the overall size of the triangle and game mathematics.

Finally, if the player has elected to play the three game sequence, they are then presented with a further screen for placing their modified bingo wager.

At predetermined time intervals, the game controller 944 initiates a new common draw phase for determining game outcomes for all players that have completed their game selections and wagers as described above. In the presently described embodiment, a simulated roulette wheel is displayed for determining the outcome of the modified roulette game, while a simulated blower apparatus is used for drawing balls which are used to determine the outcomes of the modified keno and bingo games. It will be understood that the drawn balls may also be distinctively marked to show that they relate to a particular game.

An example draw phase implemented by the controller 944 will now be described. In a first stage of the draw the controller 944 randomly determines a winning bail for the roulette game. The display is then controlled to display a virtual spin of a roulette wheel with the winning ball being highlighted on the display 950. The winning ball is also displayed on each of the player user interfaces 942. All roulette winning wagers are determined by the game controller 944 and paid out in the usual manner.

In the next stage of the draw phase, a graphical random keno ball selection sequence is carried out by the controller 944 for determining the 2^{nd} through 9^{th} winning balls for the modified keno game (the first winning number is the same number from one roulette game). All keno winning bets are determined and paid to players.

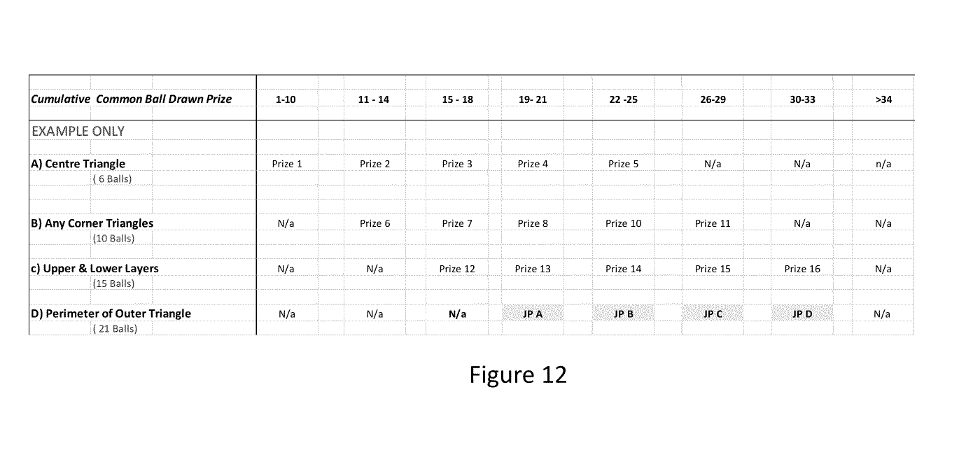

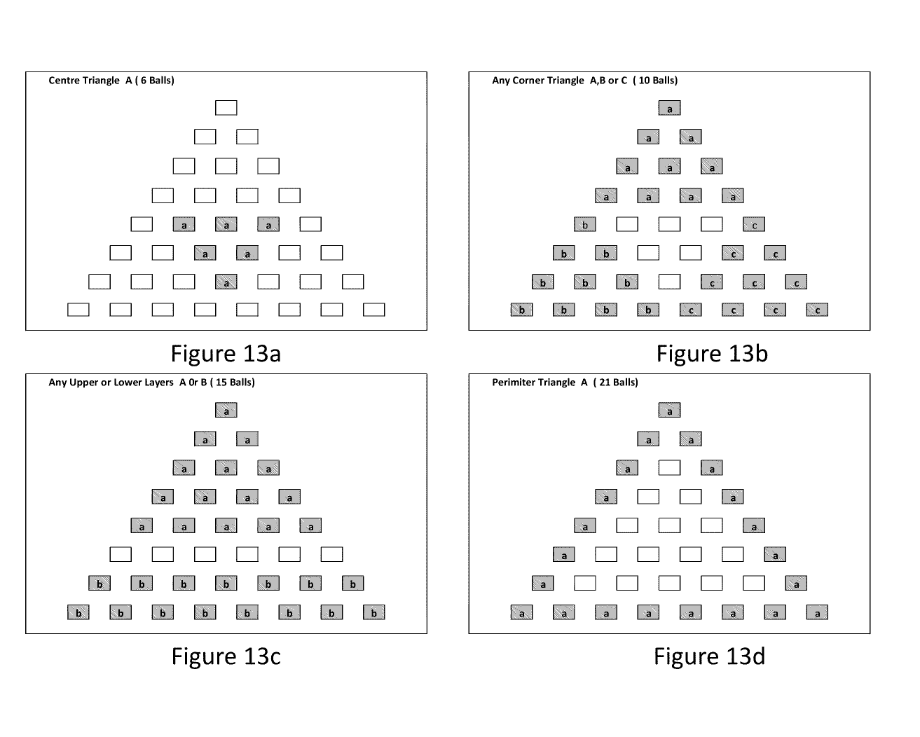

Prior to implementing the third stage of the draw phase (i.e. for determining winning Bingo patterns), the controller 942, with the aid of the RNG, randomly repopulates the triangular wager layout for each player with numbered balls from the draw set (thereby providing each player with a unique virtual game card, as required for a game of Bingo). This unique virtual card is then displayed on the respective player terminals 942 with any of the already drawn balls automatically marked thereon (in this case by highlighting those balls on the player terminal). Remaining balls from the draw set are continuously drawn until one or more of the players achieves a predetermined winning pattern (in this case being a triangular pattern) and is declared the winner. FIGS. 12 and 13 respectively snow an example prize table and corresponding prize winning patterns for a modified bingo game in accordance with an embodiment described herein. As shown in FIG. 12, jackpots are awardable to players who have completed a 21 ball prize pattern. The size of the jackpot diminishes with the number of balls being drawn to complete the pattern.

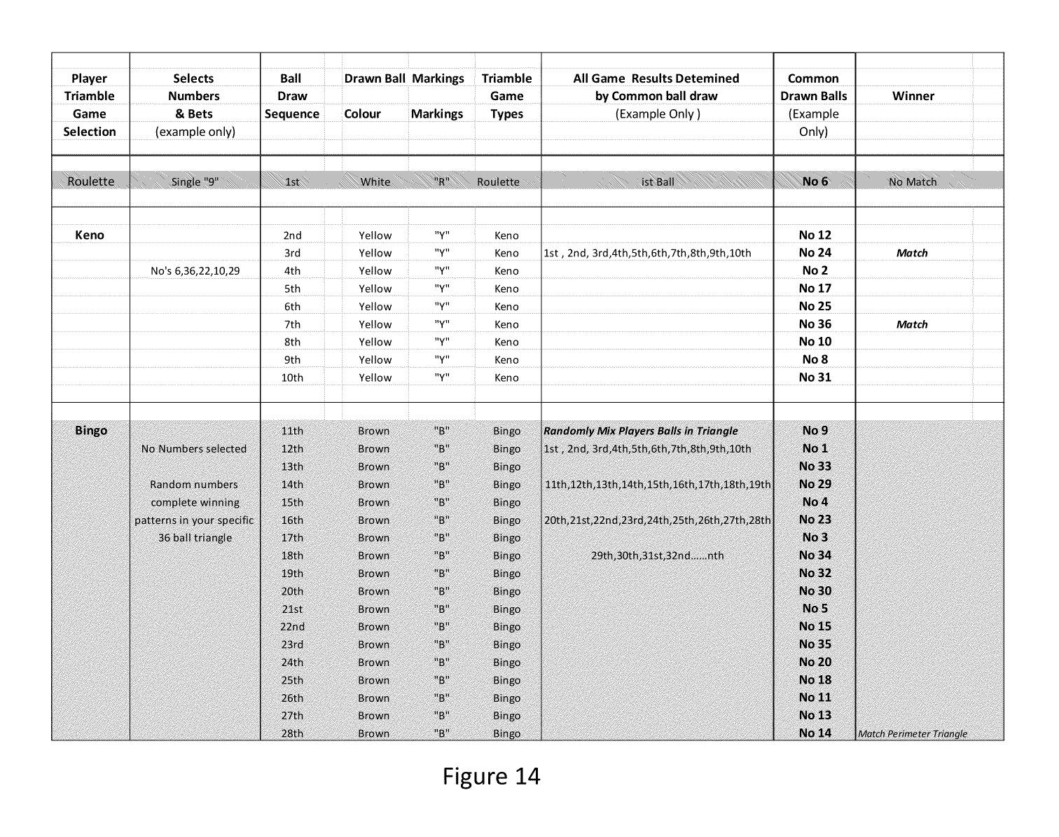

FIG. 14 shows some example player wager selections and draw outcomes for the above-described muitigame to further illustrate game play.

The afore-mentioned embodiments provide new forms of lottery and casino style games having prize structures which are easily understood and transparent to the players. Particular game embodiments may also advantageously provide attractive odds with prizes being instantaneously paid on a regular basis.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of conducting a wager game comprising:
allowing a prayer to place individual game wagers across a plurality of games to be played in the wager game;
implementing a common draw phase in which a plurality of symbols are randomly drawn from a symbol draw set to determine outcomes of the plurality of games, such that at least one of the drawn symbols is used for determining, at least in part, the outcome for each of the plurality of individual games.

2. A method in accordance with claim 1, wherein each of the games is played on a common, game layout.

3. A method in accordance with claim 2, wherein the common game layout is a triangular game board populated with a triangular number of symbols corresponding to symbols available for selection from the draw set.

4. A method in accordance with claim 3, wherein the triangular number is 32.

5. A method in accordance with claim 3, further comprising allowing the player to select the individual games to play from a set of selectable games.

6. A method in accordance with claim 5, wherein at least one of the individual games is a matching game whereby drawn symbols are matched against symbols on a player game card and prizes awarded for completing triangular patterns on the game card.

7. A method in accordance with claim 1, wherein the individual games are played in sequence.

8. A method in accordance with claim 1, wherein the individual games are played concurrently.

9. A method in accordance with claim 7, wherein individual subsets of the drawn symbols are utilised for determining outcomes for the respective games.

10. A method in accordance with claim 9, wherein the individual subsets of symbols are distinctly marked.

11. A method in accordance with claim 9, wherein the first drawn subset of symbols is utilised, at least in part, for determining the outcomes for each of the plurality of individual games.

12. A method in accordance with claim 1, wherein the individual games are selected from the group comprising:
modified keno, modified bingo ana modified roulette.

13. A method in accordance with claim 1, further comprising implementing the wager game as a multiplayer game whereby the common draw phase is used for determining the outcomes for all player wagers placed across individual games.

14. A gaming apparatus for conducting a wager game comprising:
a player terminal for allowing a player to place individual game wagers across a plurality of games;
a game controller for implementing a common draw phase m which a plurality of symbols are randomly drawn from a symbol set to determine outcomes of the plurality of games, such that at least one of the drawn symbols is used for determining, at least in part, the outcome for each of the plurality of individual games.

15. A method of conducting a roulette style wager game, comprising:
providing a wager space comprising a triangular number of symbols presented in a triangular grouping, the symbols presented in the triangular grouping corresponding to symbols in a draw set;
allowing a player to place a single symbol wager relating to a single drawn symbol;
allowing a player to place a combined symbol wager relating to a combination of drawn symbols; and
implementing a draw phase in which a plurality of symbols are randomly selected from the draw set, such that a first subset of the drawn symbols is used to determine the outcome of the single symbol wager and a second subset of drawn symbols is used to determine the outcome of the combined symbol wager.

16. A method in accordance with claim 15, wherein the first subset of symbols comprises the first drawn symbol and the second subset of symbols comprises all of the drawn symbols.

17. A method in accordance with claim 15, wherein the first subset of symbols comprises the first drawn symbol and the second subset of symbols comprises the remainder of the drawn symbols.

18. A method in accordance with claim 15, wherein the number of drawn symbols is 3.

19. A method in accordance with claim 15, further comprising implementing the draw phase using a roulette wheel having individual pockets associated with respective ones of the symbols in the draw set.

20. A game apparatus comprising:
a wager space comprising a triangular number of symbols presented in a triangular grouping, the symbols presented in the triangular grouping corresponding to symbols in a draw set;
a wager module operable to receive from a player (i) a single symbol wager relating to a single drawn symbol; and
(ii) a combined symbol wager relating to a combination of drawn symbols; and
a draw apparatus operable to implement a draw phase in which a plurality of symbols are randomly selected from the draw set, such that a first subset of the drawn symbols is used to determine the outcome of the single symbol wager and a second subset of drawn symbols is used to determine the outcome of the combined symbol wager.
